(19) United States
(12) Patent Application Publication
(10) Pub. No.: US 2024/0411621 A1
(43) Pub. Date: Dec. 12, 2024

(54) EVENT DATA STRUCTURE ROUTING AND/OR PROCESSING VIA AN EVENT PROCESSOR PLATFORM

(71) Applicant: HONEYWELL INTERNATIONAL INC., CHARLOTTE, NC (US)

(72) Inventors: WOLFGANG GUNTHER DINKEL, Mannheim (DE); ZHENG LI, Frankfurt am Main (DE); CHIAHSUN HO, Lawrenceville, GA (US); AMIT KUMAR, Munster (DE)

(21) Appl. No.: 18/329,678

(22) Filed: Jun. 6, 2023

(51) Int. Cl. G06F 9/54

(52) U.S. Cl. CPC G06F 9/542

(57) ABSTRACT

Various embodiments relate to event data structure routing and/or processing via an event processor platform. In an implementation, an event data structure is received. The event data structure can be generated by a mobile device based on an inspection event related to an asset located within an operational environment. Additionally, a first portion of the event data structure can include at least one event parameter identifier and a second portion of the event data structure comprises event data. In response to the event data structure, the at least one event parameter identifier is compared to a set of predefined event parameter rules for respective event processors of a set of event processors. Additionally, the event data structure is routed to a particular event processor in response to a determination that the at least one event parameter identifier satisfies the set of predefined event parameter rules.

### TECHNICAL FIELD

The present disclosure generally relates to digitally transforming data related to assets in an operational environment, and more particularly to routing and/or processing of data related to assets in an operational environment.

### BACKGROUND

An operational environment generally includes assets such machines, equipment, and/or other types of assets. Traditionally, digitally maintaining data related to assets and/or related processes in an operational environment generally involves manual configuration of data objects associated with each asset. However, if each individual data object related to each respective asset is not properly reconfigured when a change or update to a data object or function of a particular type of asset is made in the operational environment, performance of assets and/or related processes may be reduced.

### SUMMARY

The details of some embodiments of the subject matter described in this specification are set forth in the accompanying drawings and the description below. Other features, aspects, and advantages of the subject matter will become apparent from the description, the drawings, and the claims.

In an embodiment, a system comprises one or more processors and a memory having program code stored thereon. The program code, in execution with the at least one processor, causes the system to receive an event data structure generated by a mobile device based on an inspection event related to an asset located within an operational environment. In one or more embodiments, a first portion of the event data structure includes at least one event parameter identifier related to the inspection event and/or a second portion of the event data structure comprises event data related to the inspection event. In one or more embodiments, in response to the event data structure, the program code, in execution with the at least one processor, additionally or alternatively causes the system to compare the at least one event parameter identifier to a set of predefined event parameter rules for respective event processors of a set of event processors. In one or more embodiments, in response to the event data structure, the program code, in execution with the at least one processor, additionally or alternatively causes the system to route the event data structure to a particular event processor from the set of event processors in response to a determination that the at least one event parameter identifier satisfies the set of predefined event parameter rules for the respective event processors. In one or more embodiments, in response to the event data structure, the program code, in execution with the at least one processor, additionally or alternatively causes the system to process event data of the event data structure using the particular event processor.

In another embodiment, a computer-implemented method is provided. The computer-implemented method provides for receiving an event data structure generated by a mobile device based on an inspection event related to an asset located within an operational environment. In one or more embodiments, a first portion of the event data structure comprises at least one event parameter identifier related to the inspection event and/or a second portion of the event data structure comprises event data related to the inspection event. In one or more embodiments, in response to the event data structure, the computer-implemented method additionally or alternatively provides for comparing the at least one event parameter identifier to a set of predefined event parameter rules for respective event processors of a set of event processors. In one or more embodiments, in response to the event data structure, the computer-implemented method additionally or alternatively provides for routing the event data structure to a particular event processor from the set of event processors in response to a determination that the at least one event parameter identifier satisfies the set of predefined event parameter rules for the respective event processors. In one or more embodiments, in response to the event data structure, the computer-implemented method additionally or alternatively provides for processing event data of the event data structure using the particular event processor.

In yet another embodiment, a computer program product comprises at least one non-transitory computer-readable storage medium having computer-readable program code portions stored therein. The computer-readable program code portions comprise an executable portion configured to receive an event data structure generated by a mobile device based on an inspection event related to an asset located within an operational environment. In one or more embodiments, a first portion of the event data structure comprises at least one event parameter identifier related to the inspection event and/or a second portion of the event data structure comprises event data related to the inspection event. In one or more embodiments, in response to the event data structure, the computer-readable program code portions also comprise an executable portion configured to compare the at least one event parameter identifier to a set of predefined event parameter rules for respective event processors of a set of event processors. In one or more embodiments, in response to the event data structure, the computer-readable program code portions also comprise an executable portion configured to route the event data structure to a particular event processor from the set of event processors in response to a determination that the at least one event parameter identifier satisfies the set of predefined event parameter rules for the respective event processors. In one or more embodiments, in response to the event data structure, the computer-readable program code portions also comprise an executable portion configured to process event data of the event data structure using the particular event processor.

### BRIEF DESCRIPTIONS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an exemplary networked computing system environment, in accordance with one or more embodiments described herein;

FIG. 2 illustrates a schematic block diagram of a framework of an IoT platform of the networked computing system, in accordance with one or more embodiments described herein;

FIG. 3 illustrates a system that provides an exemplary environment related to an event processor platform associated with an event processor system and a set of event processors, in accordance with one or more embodiments described herein;

FIG. 4 illustrates an exemplary event processor system, in accordance with one or more embodiments described herein;

FIG. 5 illustrates an exemplary user computing device system, in accordance with one or more embodiments described herein;

FIG. 6 illustrates an exemplary system associated with an event dispatcher, in accordance with one or more embodiments described herein;

FIG. 7 illustrates an exemplary electronic interface in accordance with one or more embodiments described herein;

FIG. 8 illustrates another exemplary electronic interface in accordance with one or more embodiments described herein;

FIG. 9 illustrates another exemplary electronic interface in accordance with one or more embodiments described herein;

FIG. 10 illustrates another exemplary electronic interface in accordance with one or more embodiments described herein;

FIG. 11 illustrates another exemplary electronic interface in accordance with one or more embodiments described herein;

FIG. 12 illustrates another exemplary electronic interface in accordance with one or more embodiments described herein;

FIG. 13 illustrates another exemplary electronic interface in accordance with one or more embodiments described herein;

FIG. 14 illustrates a process flow diagram for event data structure routing and/or processing, in accordance with one or more embodiments described herein; and

FIG. 15 illustrates a functional block diagram of a computer that may be configured to execute techniques described in accordance with one or more embodiments described herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment.” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can.” “may,” “could,” “should.” “would.” “preferably.” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

In general, the present disclosure provides for an “Internet-of-Things” or “IoT” platform for enterprise performance management that uses real-time accurate models and visual analytics to deliver intelligent actionable recommendations for sustained peak performance of an enterprise or organization. The IoT platform is an extensible platform that is portable for deployment in any cloud or data center environment for providing an enterprise-wide, top to bottom view, displaying the status of processes, assets, people, and safety. Further, the IoT platform of the present disclosure supports end-to-end capability to execute digital twins against process data and to translate the output into actionable insights, as detailed in the following description.

An operational environment generally includes assets such machines, equipment, and/or other types of assets. Traditionally, digitally maintaining data related to assets and/or related processes in an operational environment generally involves manual configuration of data objects associated with each asset. However, if each individual data object related to each respective asset is not properly reconfigured when a change or update to a data object or function of a particular type of asset is made in the operational environment, performance of assets and/or related processes may be reduced.

Given the scope of typical operational environments, it can take hundreds of man-hours to configure and/or manage databases associated with assets and related operational processes of a particular operational environment. For example, it is typically desirable to assign each asset to a respective data object comprising the particular properties and operational functions associated with the asset, which can lead to reduced asset performance, inefficiencies, and/or misallocated technical resources, especially when there are multiple instances of the same type of asset employed across the operational environment. These problems are exponentially compounded depending on the multitude of various types of assets in a given operational environment. Furthermore, when a particular type of asset is to be updated or changed, it is typically desirable to update or change each instance of that particular type of asset. For example, it is generally desirable to update or change the respective data objects associated with the assets in a related database and/or server system. Additionally, different types of data objects and/or different types of technology stacks are typically deployed in an operational environment. This creates further redundancies, excessive maintenance, repeated development effort, and/or lack of interoperability between data, assets and/or related operational processes.

Moreover, data analytics and/or digital transformation of data related to assets generally involves human interaction. However, often times a specialized worker (e.g., a manager) is responsible for a large portfolio of assets (e.g., 1000 buildings each with 100 assets such as a boiler, a chiller, a pump, sensors, etc.). Therefore, it is generally difficult to identify and/or fix issues with the large portfolio of assets. For example, in certain scenarios, multiple assets (e.g., 25 assets) from the large portfolio of assets may have an issue. Furthermore, a limited amount of time is traditionally spent on modeling of data related to assets to, for example, provide insights related to the data. As such, computing resources related to data analytics and/or digital transformation of data related to assets are traditionally employed in an inefficient manner.

As another example, it is generally desirable for management personnel (e.g., executives, managers, etc.) to be provided with an understanding of which assets in an operational environment require inspection or service. Additionally, it is generally desirable for management personnel (e.g., executives, managers, etc.) to be provided with improved technology to facilitate inspection or servicing of assets in an operational environment. For example, traditional dashboard technology generally involves manual configuration of the dashboard to, for example, provide different insights for assets. Furthermore, traditional dashboard technology employed with dashboard data modeling of assets is generally implemented outside of a core application and/or asset model. Therefore, it is generally difficult to execute data modeling for assets in an efficient and/or accurate manner.

Thus, to address these and/or other issues, various embodiments of the present disclosure relate to computer-implemented methods, systems, and computer-program products directed to event data structure routing and/or processing via an event processor platform. An event data structure can be related to an asset and/or an operational process within an operational environment. As disclosed herein, an “operational environment” may be an industrial environment, a manufacturing environment, a process environment, a warehouse environment, a manufacturing site, a processing site, a plant, or another type of environment that includes one or more assets and/or one or more operational processes. The asset is a physical asset within the operational environment such as, for example, a machine, equipment, a tool, or another type of physical asset. In certain embodiments, the asset is an industrial asset included in an industrial environment and/or related to one or more industrial processes. In certain embodiments, the asset is a warehouse asset included in a warehouse environment and/or related to one or more warehouse processes. In one or more embodiments, the operational process is a process that controls one or more portions of an asset and/or generates one or more goods, products, items, or materials. In one or more embodiments, the operational process involves one or more electrical, mechanical, chemical, and/or physical steps to control one or more portions of an asset and/or to generate one or more goods, products, items, or materials.

In certain embodiments, an event data structure can be related to an event such as, for example, an industrial event, a process event, an inspection event, a change event, a service event, a maintenance event, a warehouse event, a packing/unpacking event, or another type of event associated with an asset and/or an operational process within an operational environment. In one or more embodiments, an event can be related to one or more tasks associated with a particular operational environment management process and/or a particular asset employed in an operational environment. For example, an event can be related to an asset task such as “maintenance” or “safety”. An asset task can be a task such as “check lube,” “replace lube,” “check safety seal,” etc. In another example, an event can correspond to “compressor temperature captured” or “operational limit deviated” for an asset and/or an operational process within an operational environment.

In various embodiments, an event data structure can be generated by a mobile device. For example, an inspection event, a change event, a service event, a maintenance event, or another type of event for an asset and/or an operational process within an operational environment can be initiated, configured, or deployed via a workflow controlled by a user interface of the mobile device. In various embodiments, routing of event data structures can include filtering of event data structure received from mobile device prior to the event data structures being provided to a cloud platform. The event data structures can additionally or alternatively be queued for asynchronous processing by the cloud platform. Additionally or alternatively, event data structures can be filtered after being provided to a cloud platform.

In various embodiments, an event data structure can be related to an inspection round checklist comprising a list of tasks associated with one or more assets and/or one or more operational processes in an operational environment. In various embodiments, a user interface of the mobile device can display the list of tasks and/or interactive user interface elements related to the one or more assets and/or one or more operational processes. For example, the cloud platform can transmit, via a communications network, an inspection round checklist with the list of tasks to the mobile device. In one or more embodiments, the inspection round checklist can be generated and transmitted to the mobile device on a schedule (e.g., daily, weekly, monthly, etc.) such that one or more plant operators may perform the tasks in the inspection round checklist on a routine basis. Based on interactions with the list of tasks via the user interface of the mobile device, one or more event data structures can be generated.

In various embodiments, the event processor platform can include a set of event processors configured for processing event data structures based on respective event processor rules. In various embodiments, the event processor rules can include predefined event parameter rules for event data structures. In various embodiments, the set of event processors can be related to an event counter, an event queuer, an event re-processor, a cold-storage for event data structures, a hot-storage for event data structures, a hypertext transfer protocol (HTTP) connector processor for redirecting event data structures to third-party logging frameworks, a stream processing processor configured to allocate event data structure to an event stream, etc. In various embodiments, the set of event processors can configure event data structures based on access rules and/or querying rules such that the event data structures can be accessed and/or queried via an application programming interface (API) such as, for example, a representational state transfer (REST) API.

By utilizing event data structure routing and/or processing as disclosed herein, semantically correct information related to assets and/or operational processes can be provided. Additionally, by utilizing event data structure routing and/or processing as disclosed herein, improved querying of event data structure and/or improved transformation of event data structures into respective logging or real-time monitoring formats can be provided.

In various embodiments, the mobile device can be configured with a mobile application that provides for capture of event data structures. Based on event parameters of the event data structure, the event data structure can be temporarily stored on the mobile device and synced to the cloud platform in response to network connectivity between the mobile device and the cloud platform. In various embodiments, a user identifier associated with the mobile application can be registered with the cloud platform in order to facilitate authentication of event data structures.

In various embodiments, the cloud platform can be an event stream framework that includes cloud services (e.g., cloud microservices), an event receiver, an event listener, and/or an event dispatcher for routing and/or processing event data structures. The event receiver can be a cloud service endpoint configured to receive event data structures captured on mobile devices. The event receiver can additionally publish the event data structures to an event processing infrastructure of the cloud platform. The event listener can be configured for pre-processing of event data structures by allocating event data structures to data queues such that one or more actions with respect to the event data structures can be subsequently performed by the cloud platform. In certain embodiments, the event listener can additionally or alternatively be configured for pre-filtering of the event data structures to facilitate the subsequent processing by the cloud platform. In certain embodiments, the data queues can be configured based on event topics. In certain embodiments, the pre-filtering can include transforming the event data structures into a binary format and/or in a format to support a particular type of processing by the cloud platform.

The event dispatcher can be configured to select a particular event processor for an event data structure based on a set of configurable filters for event processors. In various embodiments, the set of event processors associated with the event dispatcher can include an HTTP connector processor configured to redirect event data structures to a particular HTTP endpoint of a network, a cold-storage processor configured to store event data structure in a datastore associated with data archiving functionality for event data structures, a hot-storage processor configured to store event data structures in a relational database associated with data querying functionality for event data structures, a stream processing processor configured to allocate event data structure to an event stream for rendering of visualization data associated with the event data structure via an electronic interface of a mobile device, and/or one or more other types of event processors. In various embodiments, the event dispatcher can support different serializers to store event data structure in different formats (e.g., JSON, YaLM, XML, Syslog, etc.) to facilitate log-scraping, logging, alerting, and/or real-time monitoring. In various embodiments, the event dispatcher can utilize an event finder REST API to access and/or query event data structures.

As such, by employing one or more techniques related to event data structure routing and/or processing as disclosed herein, various technical improvements can be achieved. For example, by employing one or more techniques related to event data structure routing and/or processing as disclosed herein, an amount of data for storage and/or memory allocation by a server system associated with a particular operational environment can be reduced while also optimizing setting specific configuration parameters (e.g., operational limits) for assets and/or operational processes. Furthermore, an amount of time for configuring a data model of an operational environment can be reduced, and, once configured, the data model can be reused for generating inspection round checklists, adding additional physical assets to the operational environment and initializing corresponding digital asset instances, and/or creating new data models associated with one or more other operational environments. Moreover, a number of computing resources for querying of one or more databases that stores data related to assets and/or operational processes can be reduced. Additionally, by employing one or more techniques related to event data structure routing and/or processing as disclosed herein, asset performance can be optimized. Performance of a processing system associated with data analytics can also be improved by employing one or more techniques related to event data structure routing and/or processing as disclosed herein. For example, a number of computing resources, a number of a storage requirements, and/or number of errors associated with data analytics can be reduced by employing one or more techniques disclosed herein.

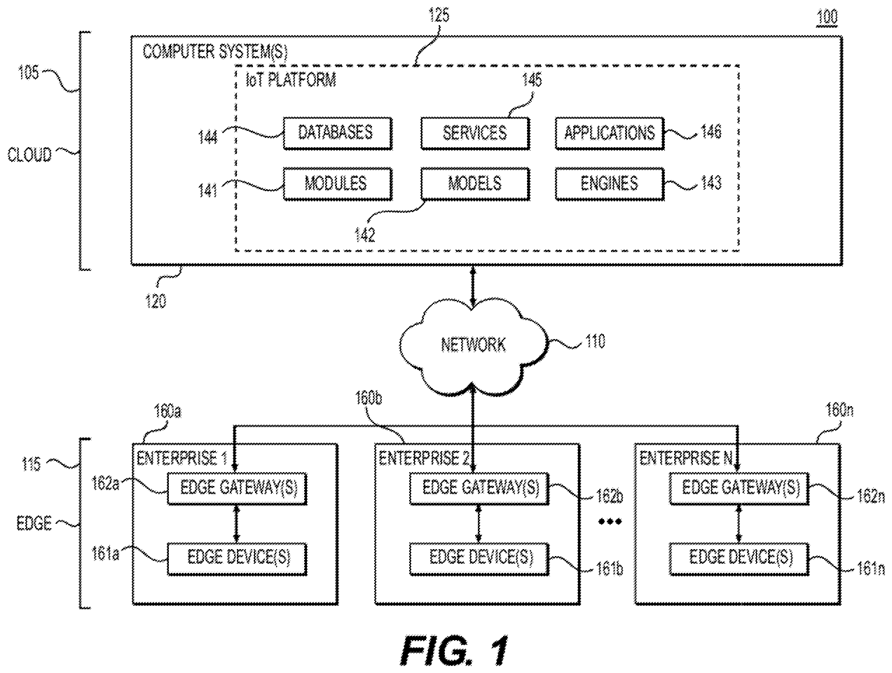

FIG. 1 illustrates an exemplary networked computing system environment 100, according to the present disclosure. As shown in FIG. 1, networked computing system environment 100 is organized into a plurality of layers including a cloud layer 105, a network layer 110, and an edge layer 115. As detailed further below, components of the edge 115 are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device and should not be construed as limiting on the types of computing systems useable within IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100. In certain embodiments, the networked computing system environment 100 is an on-premise networked computing system where the edge 115 is configured as a process control network and the cloud 105 is configured as an enterprise network.

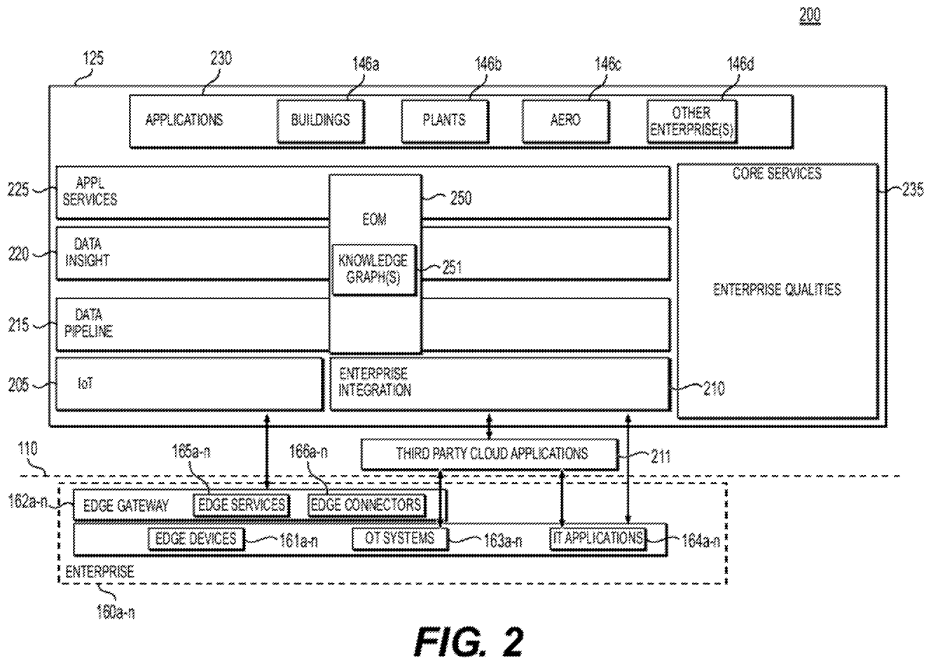

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141. models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or entity that includes any number of local devices.

According to various embodiments, the edge devices 161a-161n represent any of a variety of different types of devices that may be found within the enterprises 160a-160n. Edge devices 161a-161n are any type of device configured to access network 110, or be accessed by other devices through network 110, such as via an edge gateway 162a-162n. According to various embodiments, edge devices 161a-161n are “IoT devices” which include any type of network-connected (e.g., Internet-connected) device. For example, in one or more embodiments, the edge devices 161a-161n include assets, sensors, actuators, processors, computers, valves, pumps, ducts, vehicle components, cameras, displays, doors, windows, security components, boilers, chillers, pumps, air handler units, HVAC components, factory equipment, and/or any other devices that are connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, in one or more embodiments, the edge 115 include operational technology (OT) systems 163a-163n and information technology (IT) applications 164a-164n of each enterprise 160a-160n. The OT systems 163a-163n include hardware and software for detecting and/or causing a change, through the direct monitoring and/or control of industrial equipment (e.g., edge devices 161a-161n), assets, processes, and/or events. The IT applications 164a-164n includes network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. According to various embodiments, the communication interfaces of the edge gateways 162a-162n include one or more cellular radios, Bluetooth, WiFi, near-field communication radios, Ethernet, or other appropriate communication devices for transmitting and receiving information. According to various embodiments, multiple communication interfaces are included in each gateway 162a-162n for providing multiple forms of communication between the edge devices 161a-161n, the gateways 162a-162n, and the cloud 105 via network 110. For example, in one or more embodiments, communication are achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162a-162n also include a processor and memory for storing and executing program instructions to facilitate data processing. For example, in one or more embodiments, the edge gateways 162a-162n are configured to receive data from the edge devices 161a-161n and process the data prior to sending the data to the cloud 105. Accordingly, in one or more embodiments, the edge gateways 162a-162n include one or more software modules or components for providing data processing services and/or other services or methods of the present disclosure. With reference to FIG. 2, each edge gateway 162a-162n includes edge services 165a-165n and edge connectors 166a-166n. According to various embodiments, the edge services 165a-165n include hardware and software components for processing the data from the edge devices 161a-161n. According to various embodiments, the edge connectors 166a-166n include hardware and software components for facilitating communication between the edge gateway 162a-162n and the cloud 105 via network 110, as detailed above. In some cases, any of edge devices 161a-n, edge connectors 166a-n, and edge gateways 162a-n have their functionality combined, omitted, or separated into any combination of devices. In other words, an edge device and its connector and gateway need not necessarily be discrete devices.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations and/or analytics for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, in one or more embodiments, each layer 205-235 includes one or more of the modules 141, models 142, engines 143, databases 144, services 145, applications 146, or combinations thereof. In some embodiments, the layers 205-235 are combined to form fewer layers. In some embodiments, some of the layers 205-235 are separated into separate, more numerous layers. In some embodiments, some of the layers 205-235 are removed while others may be added. In certain embodiments, the framework 200 can be an on-premise framework where the edge devices 161a-161n are configured as part of a process control network and the IoT platform 125 is configured as an enterprise network.

The IoT platform 125 is a model-driven architecture. Thus, the extensible object model 250 communicates with each layer 205-230 to contextualize site data of the enterprise 160a-160n using an extensible graph-based object model (or “asset model”). In one or more embodiments, the extensible object model 250 is associated with knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 include resource description framework (RDF) graphs. As used herein, a “RDF graph” is a graph data model that formally describes the semantics, or meaning. of information. The RDF graph also represents metadata (e.g., data that describes data). According to various embodiments, knowledge graphs 251 also include a semantic object model. The semantic object model is a subset of a knowledge graph 251 that defines semantics for the knowledge graph 251. For example, the semantic object model defines the schema for the knowledge graph 251.

As used herein, EOM 250 includes a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, in one or more embodiments, the model describes the type of sensors mounted on any given asset (e.g., edge device 161a-161n) and the type of data that is being sensed by each sensor. According to various embodiments, a KPI framework is used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations.

Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior. In one or more embodiments, each of the key attribute contributing to one or more metrics to drive a dashboard is marked with one or more metric tags such that a dashboard visualization is generated.

The modeling phase includes an onboarding process for syncing the models between the edge 115 and the cloud 105. For example, in one or more embodiments, the onboarding process includes a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, in one or more embodiments, the knowledge graph 251 receives “TMP” during the modeling phase and determine that “TMP” relates to “temperature.” The generated models are then published. The complex onboarding process includes the knowledge graph 251 receiving the raw model data, receiving point history data, and receiving site survey data. According to various embodiments, the knowledge graph 251 then uses these inputs to run the context discovery algorithms. According to various embodiments, the generated models are edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, in one or more embodiments, data is ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT platform 205. In some embodiments, only authorized data is sent to the IoT platform 125, and the IoT platform 125 only accepts data from authorized edge gateways 162a-162n and/or edge devices 161a-161n. According to various embodiments, data is sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. According to various embodiments, the IoT layer 205 also includes components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third-party applications 211 rather than, or in combination with, receiving the data from the edge devices 161a-161n directly. In certain embodiments, the enterprise integration layer 210 enables a scalable architecture to expand interfaces to multiple systems and/or system configurations. In certain embodiments, the enterprise integration layer 210 enables integration with an indoor navigation system related to the enterprise 160a-160n.

The data pipeline layer 215 includes one or more components for data cleansing/enriching, data transformation, data calculations/aggregations, and/or API for data streams. Accordingly, in one or more embodiments, the data pipeline layer 215 pre-processes and/or performs initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 215 employs models and templates to define calculations and analytics. Additionally or alternatively, according to various embodiments, the data pipeline layer 215 employs models and templates to define how the calculations and analytics relate to the assets (e.g., the edge devices 161a-161n). For example, in an embodiment, a pump template defines pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. According to various embodiments, the actual calculation or analytic logic is defined in the template or it may be referenced. Thus, according to various embodiments, the calculation model is employed to describe and control the execution of a variety of different process models. According to various embodiments, calculation templates are linked with the asset templates such that when an asset (e.g., edge device 161a-161n) instance is created, any associated calculation instances are also created with their input and output parameters linked to the appropriate attributes of the asset (e.g., edge device 161a-161n).

According to various embodiments, the IoT platform 125 supports a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, in one or more embodiments, the IoT platform 125 drill downs from a high-level condition to understand the contributing factors, as well as determining the potential impact a lower level condition may have. There may be multiple fault models for a given enterprise 160a-160n looking at different aspects such as process, equipment, control, and/or operations. According to various embodiments, each fault model identifies issues and opportunities in their domain, and can also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 125 provides recommendations about an optimal corrective action to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 125 enables operators to quickly initiate maintenance measures when irregularities occur. According to various embodiments, the digital twin architecture of the IoT platform 125 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, process design is integrated with feed conditions and production requirement. Process changes and technology improvement provide opportunities that enable more effective maintenance schedule and deployment of resources in the context of production needs. The fault detection and diagnostics include generalized rule sets that are specified based on industry experience and domain knowledge and can be easily incorporated and used working together with equipment models. According to various embodiments, the descriptive models identifies a problem and the predictive models determines possible damage levels and maintenance options. According to various embodiments, the descriptive models include models for defining the operating windows for the edge devices 161a-161n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TDSB), relational/document databases, data lakes, blob, files, images, and videos, and/or an API for data query. According to various embodiments, when raw data is received at the IoT platform 125, the raw data is stored as time series tags or events in warm storage (e.g., in a TSDB) to support interactive queries and to cold storage for archive purposes. According to various embodiments, data is sent to the data lakes for offline analytics development. According to various embodiments, the data pipeline layer 215 accesses the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146a-d. The applications layer 230 includes one or more applications 146a-d of the IoT platform 125. For example, according to various embodiments, the applications 146a-d includes a buildings application 146a, a plants application 146b, an aero application 146c, and other enterprise applications 146d. According to various embodiments, the applications 146 includes general applications 146 for portfolio management, asset management, autonomous control, and/or any other custom applications. According to various embodiments, portfolio management includes the KPI framework and a flexible user interface (UI) builder. According to various embodiments, asset management includes asset performance and asset health. According to various embodiments, autonomous control includes energy optimization and/or predictive maintenance. As detailed above, according to various embodiments, the general applications 146 is extensible such that each application 146 is configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. According to various embodiments, the core services 235 include data visualization, data analytics tools, security, scaling, and monitoring. According to various embodiments, the core services 235 also include services for tenant provisioning, single login/common portal, self-service admin, UI library/UI tiles, identity/access/entitlements, logging/monitoring, usage metering, API gateway/dev portal, and the IoT platform 125 streams.

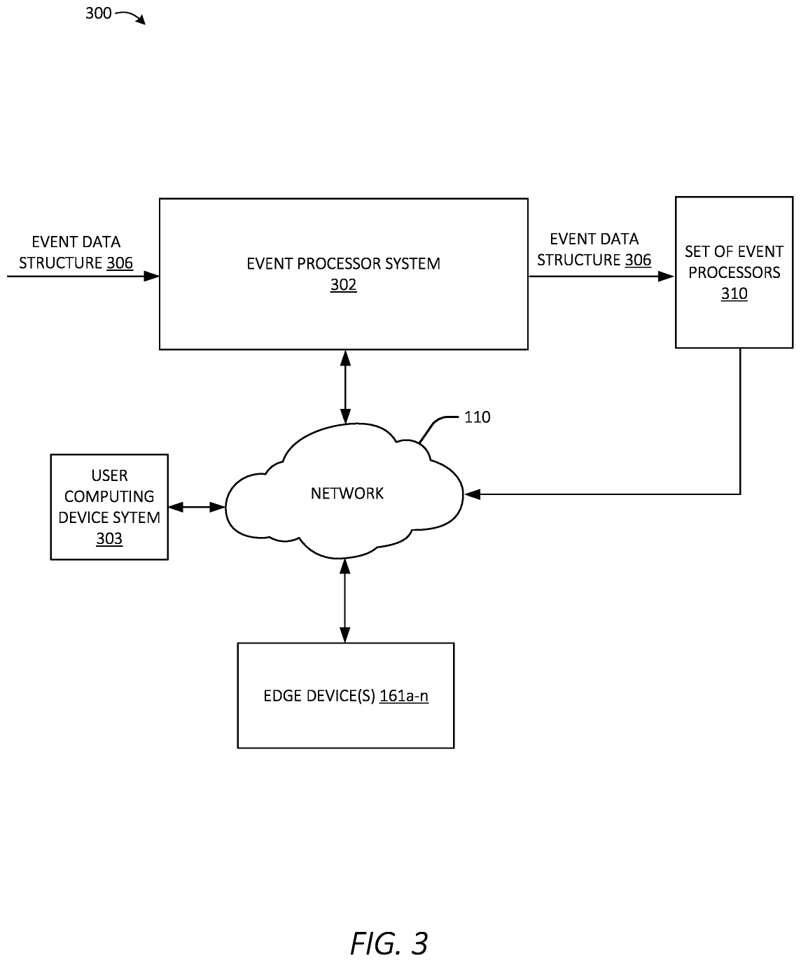

FIG. 3 illustrates a system 300 that provides another exemplary environment according to one or more described features of one or more embodiments of the disclosure. According to an embodiment, the system 300 includes an event processor system 302. The event processor system 302 is associated with one or more application products such as a cloud platform, an event processor platform, a data modeling platform, an asset management platform, an asset performance platform, a global operations platform, a site operations platform, an industrial asset platform, an industrial process platform, a digital worker platform, an energy and sustainability platform, a healthy buildings platform, an energy optimization platform, a predictive maintenance platform, a centralized control platform, and/or another type of asset platform. In one or more embodiments, the event processor system 302 receives an event data structure 306. In certain embodiments, the event processor system 302 receives the event data structure 306 via the network 110 and/or via an event stream associated with the event processor system 302. In certain embodiments, the event processor system 302 can be generated by and/or received from a user computing device system 303. The user computing device system 303 can correspond to and/or be incorporated in a mobile device such as a smartphone, a tablet computer, a mobile computer, a laptop computer, a wearable device, a virtual reality device, an augmented reality device, or another type of mobile device located remote from the event processor system 302. In certain embodiments, the event processor system 302 receive the event data structure 306 from the user computing device system 303 in response to a network connection being established between the user computing device system 303 and the network 110. For example, the event processor system 302 can receive the event data structure 306 from the user computing device system 303 in response to a network connection being established between the user computing device system 303 and the event processor system 302 accessible via the network 110.

In one or more embodiments, the event data structure 306 is related to the edge devices 161a-161n. In one or more embodiments, the edge devices 161a-161n are associated with a portfolio of assets. For instance, in one or more embodiments, the edge devices 161a-161n include one or more assets in a portfolio of assets. The edge devices 161a-161n include, in one or more embodiments, one or more databases, one or more assets (e.g., one or more machines, equipment, one or more tools, one or more industrial assets, one or more warehouse assets, one or more building assets, etc.), one or more IoT devices (e.g., one or more industrial IoT devices), one or more connected building assets, one or more sensors, one or more actuators, one or more processors, one or more computers, one or more valves, one or more pumps (e.g., one or more centrifugal pumps, etc.), one or more motors, one or more compressors, one or more turbines, one or more ducts, one or more heaters, one or more chillers, one or more coolers, one or more boilers, one or more furnaces, one or more heat exchangers, one or more fans, one or more blowers, one or more conveyor belts, one or more vehicle components, one or more cameras, one or more displays, one or more security components, one or more air handler units, one or more HVAC components, industrial equipment, factory equipment, and/or one or more other devices that are connected to the network 110 for collecting, sending, and/or receiving information. In one or more embodiments, the edge device 161a-161n include, or is otherwise in communication with, one or more controllers for selectively controlling a respective edge device 161a-161n and/or for sending/receiving information between the edge devices 161a-161n and the event processor system 302 via the network 110. The data associated with the edge devices 161a-161n includes, for example, industrial asset data, asset data related to asset properties, asset configuration data, operational functionality data, sensor data, real-time data, live property value data, event data, warehouse data, packing/unpacking event data, process data, operational data, operational limit values, fault data, location data, and/or other data associated with the edge devices 161a-161n.

In certain embodiments, at least one edge device from the edge devices 161a-161n incorporates encryption capabilities to facilitate encryption of one or more portions of the asset data. Additionally, in one or more embodiments, the event processor system 302 receives the data associated with the edge devices 161a-161n via the network 110. In one or more embodiments, the network 110 is a Wi-Fi network, an NFC network, a WiMAX network, a PAN, a short-range wireless network (e.g., a Bluetooth® network), an infrared wireless (e.g., IrDA) network, a UWB network, an induction wireless transmission network, and/or another type of network. In one or more embodiments, the edge devices 161a-161n are associated with an operational environment (e.g., an industrial environment, a manufacturing environment, a process environment, a warehouse environment, a manufacturing site, a processing site, a plant. etc.). Additionally or alternatively, in one or more embodiments, the edge devices 161a-161n are associated with components of the edge 115 such as, for example, one or more enterprises 160a-160n.

In one or more embodiments, the event processor system 302 receives the event data structure 306 based on an inspection event or another type of event related to an asset located within an operational environment associated with the edge devices 161a-n. In certain embodiments, the inspection event is related to an industrial asset located within an industrial environment associated with the edge devices 161a-n. In certain embodiments, the inspection event is related to an asset located within a processing environment associated with the edge devices 161a-n. In certain embodiments, the inspection event is related to a warehouse asset located within a warehouse environment associated with the edge devices 161a-n. In various embodiments, a first portion of the event data structure 306 includes at least one event parameter identifier related to the inspection event. Additionally, in one or more embodiments, a second portion of the event data structure 306 includes event data related to the inspection event. The at least one event parameter identifier can be included in a header portion of the event data structure 306. Additionally, the least one event parameter identifier can correspond to an event identifier, a timestamp identifier, a publisher identifier, a source type identifier, a source identifier, a event type identifier, a value identifier, a previous value identifier, a user identifier, a location identifier, and/or another type of event parameter identifier. The event data can include asset configuration data, operational functionality data, sensor data, real-time data, live property value data, process data, operational data, operational limit values, fault data, and/or other data associated with the inspection event. In certain embodiments, the event data can correspond to a value and/or a description related to a task performed with respect to an asset and/or an operational process via the inspection event. In certain embodiments, the operational process is an industrial process, a warehouse processes, or another type of operational process related to one or more assets.

In response to receiving the event data structure 306, the event processor system 302 performs routing and/or processing of the event data structure 306. In one or more embodiments, the event processor system 302 compare the at least one event parameter identifier to a set of predefined event parameter rules for respective event processors of a set of event processors 310. The set of event processors 310 can include two or more event processor respectively configured for a particular type of processing and/or routing of event data structures. In various embodiments, the processing and/or routing of event data structures includes log-scraping, logging, short term storage, long term storage, relational database queuing, event queuing, event visualization via a web frontend interface, external framework routing, alerting, real-time monitoring, and/or another type of processing and/or routing of event data structures. The set of predefined event parameter rules for the respective event processors of the set of event processors 310 can define rules for selecting the respective event processors for the processing and/or routing of event data structures.

In one or more embodiments, the set of event processors 310 include an HTTP connector processor configured to redirect event data structures to a particular HTTP endpoint of the network 110, a cold-storage processor configured to store event data structure in a datastore associated with data archiving functionality for event data structures, a hot-storage processor configured to store event data structures in a relational database associated with data querying functionality for event data structures, a stream processing processor configured to allocate event data structure to an event stream for rendering of visualization data associated with the event data structure via an electronic interface of a mobile device, and/or one or more other types of event processors. In various embodiments, the respective event processors of the set of event processors 310 can support different serializers to store event data structure in different formats (e.g., JSON, YaLM, XML, Syslog, etc.) to facilitate processing and/or routing of event data structures. For example, event processors of the set of event processors 310 can be respectively configured to transform event data structures into a data format associated with a serializer component of the particular event processor. In certain embodiments, the event processor system 302 receives the event data structure 306 (e.g., from the user computing device system 303) in response to a determination that the at least one event parameter identifier matches a predefined event parameter identifier included in an API configuration data object for the set of event processors 310.

In one or more embodiments, the event processor system 302 routes the event data structure 306 to a particular event processor from the set of event processors 310 in response to a determination that the at least one event parameter identifier satisfies the set of predefined event parameter rules for the respective event processor. Additionally, the particular event processor from the set of event processors 310 can be utilized to process the event data structure 306. For example, the particular event processor from the set of event processors 310 can be utilized to process the event data of the event data structure 306. In certain embodiments, the event data structure 306 can be routed to a data queue for future processing of the event data structure 306 in response to a determination that the at least one event parameter identifier does not satisfy the set of predefined event parameter rules for the set of event processors 310.

In certain embodiments, the event processor system 302 determine whether the event data of the event data structure 306 exceeds an operational limit. Additionally, the event processor system 302 triggers one or more actions associated with an operational process related to the inspection event upon a determination that the operational limit is exceeded. The one or more actions can include: generating a user-interactive electronic interface that renders a visual representation of the event data and/or other data associated with the event data structure 306, transmitting one or more notifications associated with the event data to the user computing device system 303, adjusting an operational setting or threshold for an asset and/or operational process associated with the event data, providing an optimal process condition for an asset and/or operational process associated with the event data, adjusting a set-point or a schedule for an asset and/or operational process associated with the event data, determining a new asset task for an asset and/or operational process associated with the event data, providing an optimal maintenance option for an asset and/or operational process associated with the event data, generating a visual indicator for a digital twin for an asset associated with the event data, and/or another type of action associated with the application services layer 225, the applications layer 230, and/or the core services layer 235.

In certain embodiments where the particular event processor is an HTTP connector processor, the particular event processor can redirect the event data structure 306 to an HTTP endpoint of the network 110 based on data associated with the least one event parameter identifier and/or the event data of the event data structure 306. In certain embodiments where the particular event processor is a cold-storage processor, the particular event processor can store the event data structure 306 and/or the event data in a datastore (e.g., a cold-storage associated with long term event storage) associated with data archiving functionality. In certain embodiments where the particular event processor is a hot-storage processor, the particular event processor can store the event data structure 306 and/or the event data in a relational database (e.g., a hot-storage associated with short term event storage) associated with data querying functionality. In certain embodiments where the particular event processor is a stream processing processor, the particular event processor can allocate the event data structure 306 and/or the event data to an event stream for rendering of visualization data associated with the event data structure 306 via an electronic interface of the user computing device system 303.

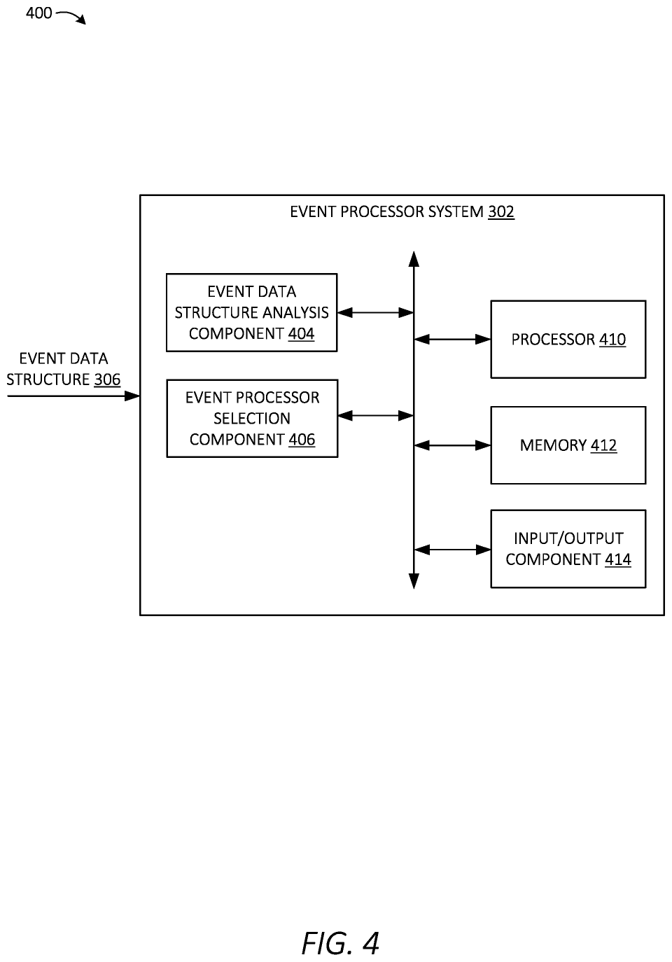

FIG. 4 illustrates a system 400 that provides an exemplary environment according to one or more described features of one or more embodiments of the disclosure. Specifically, the system 400 details the exemplary event processor system 302 (first introduced in FIG. 3) to provide a practical application of event data structure routing and/or processing to support improved performance of one or more assets and/or one or more operational processes in an operational environment. In various embodiments, the event processor system 302 provides a practical application of data analytics technology and/or digital transformation technology to facilitate event data structure routing and/or processing.

In an embodiment, the event processor system 302 works is configured as and/or integrated into a cloud computing platform. In one or more embodiments, the event processor system 302 comprises one or more processors and a memory. In one or more embodiments, the event processor system 302 corresponds to or interacts with a computer system from the computer systems 120 to facilitate event data structure routing and/or processing in accordance with the present disclosure. In one or more embodiments, the event processor system 302 corresponds to or interacts with a computer system from the computer systems 120 via the network 110. The event processor system 302 is also related to one or more technologies, such as, for example, enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

Moreover, the event processor system 302 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the event processor system 302 improves performance of a user computing device. For example, in one or more embodiments, the event processor system 302 improves processing efficiency of a user computing device, reduces power consumption of a computing device, improves quality of data provided by a user computing device, etc. In various embodiments, the event processor system 302 improves performance of a mobile device by optimizing content rendered via an interactive user interface, by reducing a number of user interactions with respect to an interactive user interface, and/or by reducing a number of computing resources required to render content via an interactive user interface.

The event processor system 302 includes an event data structure analysis component 404 and/or an event processor selection component 406. Additionally, in one or more embodiments, the event processor system 302 includes a processor 410, a memory 412, and/or an input/output component 414. In certain embodiments, one or more aspects of the event processor system 302 (and/or other systems, apparatuses and/or processes disclosed herein) constitute executable instructions embodied within a computer-readable storage medium (e.g., the memory 412). For instance, in an embodiment, the memory 412 stores computer executable component and/or executable instructions (e.g., program instructions). Furthermore, the processor 410 facilitates execution of the computer executable components and/or the executable instructions (e.g., the program instructions). In an example embodiment, the processor 410 is configured to execute instructions stored in the memory 412 or otherwise accessible to the processor 410.

The processor 410 is a hardware entity (e.g., physically embodied in circuitry) capable of performing operations according to one or more embodiments of the disclosure. Alternatively, in an embodiment where the processor 410 is embodied as an executor of software instructions, the software instructions configure the processor 410 to perform one or more algorithms and/or operations described herein in response to the software instructions being executed. In an embodiment, the processor 410 is a single core processor, a multi-core processor, multiple processors internal to the event processor system 302, a remote processor (e.g., a processor implemented on a server), and/or a virtual machine. In certain embodiments, the processor 410 is in communication with the event data structure analysis component 404, the event processor selection component 406, the memory 412, and/or the input/output component 414 via a bus to, for example, facilitate transmission of data among the processor 410, the event data structure analysis component 404, the event processor selection component 406, the memory 412, and/or the input/output component 414. The processor 410 may be embodied in a number of different ways and, in certain embodiments, includes one or more processing devices configured to perform independently. Additionally or alternatively, in one or more embodiments, the processor 410 includes one or more processors configured in tandem via a bus to enable independent execution of instructions, pipelining of data, and/or multi-thread execution of instructions.

The memory 412 is non-transitory and includes, for example, one or more volatile memories and/or one or more non-volatile memories. In other words, in one or more embodiments, the memory 412 is an electronic storage device (e.g., a computer-readable storage medium). The memory 412 is configured to store information, data, content, one or more applications, one or more instructions, or the like, to enable event processor system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the input/output component 414 is configured to receive the event data structure 306 (e.g., such as from user computing device system 303). In various embodiments, the input/output component 414 can relay the event data structure 306 to the event data structure analysis component 404, the event processor selection component 406, and/or the memory 412 for processing, decrypting, and/or compiling. Once the event data structure 306 has been processed, decrypted, and/or compiled (e.g., as by the event data structure analysis component 404 and/or the event processor selection component 406), the input/output component 414 can transmit the event data structure 306 and/or a reformatted version of the event data structure 306 to a particular event processor from the set of event processors 310.

In one or more embodiments, the event data structure analysis component 404 embodies executable computer program code, one or more computer programs, one or more executable instructions, one or more computer processes, and/or computer hardware configured to analyze and/or process the event data structure 306. For example, the event data structure analysis component 404 can compare at least one event parameter identifier of the event data structure 306 to a set of predefined event parameter rules for respective event processors of the set of event processors 110. In one or more embodiments, the event processor selection component 406 embodies executable computer program code, one or more computer programs, one or more executable instructions, one or more computer processes, and/or computer hardware configured to route the event data structure 306. For example, the event processor selection component 406 can route the event data structure 306 to a particular event processor from the set of event processors 310 in response to a determination that the at least one event parameter identifier satisfies the set of predefined event parameter rules for the respective event processor. The event data structure analysis component 404 and/or the event processor selection component 406 can additionally or alternatively perform one or more other aspects of the event processor system 302, as more fully disclosed herein.

In one or more embodiments, the event data structure analysis component 404 and/or the event processor selection component 406 perform routing and/or processing of the event data structure 306 to improve performance of one or more assets and/or one or more operational processes in an operational environment. In various embodiments, the one or more assets and/or one or more operational processes are related to the edge devices 161a-161n (e.g., the edge devices 161a-161n included in a portfolio of assets). In one or more embodiments, the edge devices 161a-161n are associated with an operational environment (e.g., an industrial environment, a manufacturing environment, a process environment, a warehouse environment, a manufacturing site, a processing site, a plant, etc.). Additionally or alternatively, in one or more embodiments, the edge devices 161a-161n are associated with components of the edge 115 such as, for example, one or more enterprises 160a-160n.

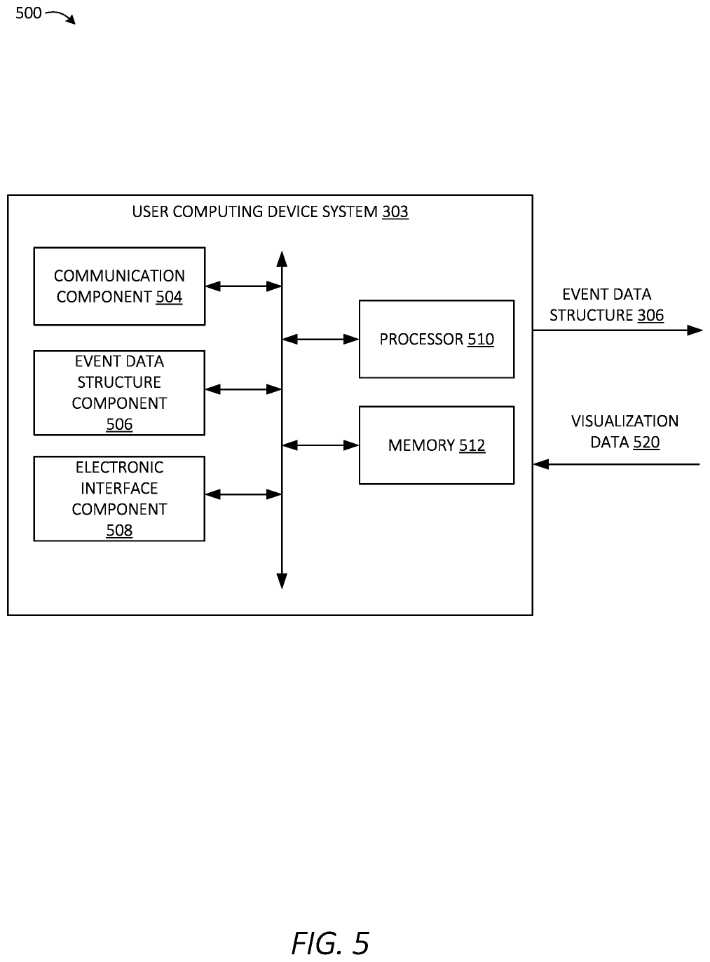

FIG. 5 illustrates a system 500 that provides an exemplary environment according to one or more described features of one or more embodiments of the disclosure. According to an embodiment, the system 500 includes a user computing device system 303 to provide a practical application of event data structure routing and/or processing to support improved performance of one or more assets and/or one or more operational processes in an operational environment. In various embodiments, the event processor system 302 provides a practical application of data analytics technology and/or digital transformation technology to facilitate event data structure routing and/or processing.

In an embodiment, the user computing device system 303 facilitates interaction with the event processor system 302. In one or more embodiments, the user computing device system 303 is a device with one or more processors and a memory. In one or more embodiments, the user computing device system 303 interacts with the event processor system 302 to provide the event data structure 306 to the event processor system 302. In one or more embodiments, the user computing device system 303 interacts with the event processor system 302 to provide an interactive user interface associated with the event data structure 306. In various embodiments, the interactive user interface is configured as a dashboard visualization associated with generating one or more inspection round checklists and/or visualization data for the event data structure 306.

Moreover, the user computing device system 303 provides an improvement to one or more technologies such as enterprise technologies, industrial technologies, connected building technologies, IoT technologies, user interface technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies. In an implementation, the user computing device system 303 improves performance of a user computing device. For example, in one or more embodiments, the user computing device system 303 improves processing efficiency of a user computing device, reduces power consumption of a computing device, improves quality of data provided by a user computing device, etc. In various embodiments, the user computing device system 303 improves performance of a user computing device by optimizing content rendered via an interactive user interface, by reducing a number of user interactions with respect to an interactive user interface, and/or by reducing a number of computing resources required to render content via an interactive user interface.

The user computing device system 303 includes a communication component 504, an event data structure component 506, and/or an electronic interface component 508. Additionally, in one or more embodiments, the user computing device system 303 includes a processor 510 and/or a memory 512. In certain embodiments, one or more aspects of the user computing device system 303 (and/or other systems, apparatuses and/or processes disclosed herein) constitute executable instructions embodied within a computer-readable storage medium (e.g., the memory 512). For instance, in an embodiment, the memory 512 stores computer executable component and/or executable instructions (e.g., program instructions). Furthermore, the processor 510 facilitates execution of the computer executable components and/or the executable instructions (e.g., the program instructions). In an example embodiment, the processor 510 is configured to execute instructions stored in the memory 512 or otherwise accessible to the processor 510.

The processor 510 is a hardware entity (e.g., physically embodied in circuitry) capable of performing operations according to one or more embodiments of the disclosure. Alternatively, in an embodiment where the processor 510 is embodied as an executor of software instructions, the software instructions configure the processor 510 to perform one or more algorithms and/or operations described herein in response to the software instructions being executed. In an embodiment, the processor 510 is a single core processor, a multi-core processor, multiple processors internal to the user computing device system 303, a remote processor (e.g., a processor implemented on a server), and/or a virtual machine. In certain embodiments, the processor 510 is in communication with the memory 512, the communication component 504, the event data structure component 506 and/or the electronic interface component 508 via a bus to, for example, facilitate transmission of data among the processor 510, the memory 512, the communication component 504, the event data structure component 506, and/or the electronic interface component 508. The processor 510 may be embodied in a number of different ways and, in certain embodiments, includes one or more processing devices configured to perform independently. Additionally or alternatively, in one or more embodiments, the processor 510 includes one or more processors configured in tandem via a bus to enable independent execution of instructions, pipelining of data, and/or multi-thread execution of instructions.

The memory 512 is non-transitory and includes, for example, one or more volatile memories and/or one or more non-volatile memories. In other words, in one or more embodiments, the memory 512 is an electronic storage device (e.g., a computer-readable storage medium). The memory 512 is configured to store information, data, content, one or more applications, one or more instructions, or the like, to enable the user computing device system 303 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

In one or more embodiments, the communication component 504 is configured to transmit the event data structure 306. For example, the communication component 504 can transmit the event data structure 306 to the event processor system 302. Additionally or alternatively, the communication component 504 is configured to receive visualization data 520 related to the event data structure 306 and/or one or more other event data structures. In one or more embodiments, the communication component 504 is configured to transmit the event data structure 306 in response to a network connection being established between the communication component 504 and the event processor system 302 via the network 110. For example, the user computing device system 303 can temporarily store the event data structure 306 and/or one or more other event data structures in the memory 512 until a network connection is established between the communication component 504 and the event processor system 302 via the network 110.

In various embodiments, the communication component 504 generates the event data structure 306 in response to an action performed with respect to a user interface configuration for an interactive user interface rendered on a visual display via the electronic interface component 508. The action can be, for example, initiating execution of an application (e.g., a mobile application) via a user computing device (e.g., a mobile device) that presents the interactive user interface, altering an interactive graphical element via the interactive user interface, or another type of action with respect to the interactive user interface rendered via the electronic interface component 508. Additionally or alternatively, in one or more embodiments, the communication component 504 generates the event data structure 306 in response to execution of a user authentication process via a user computing device (e.g., a mobile device). For example, in an embodiment, the user authentication process is associated with password entry, facial recognition, biometric recognition, security key exchange, and/or another security technique associated with a user computing device.

In various embodiments, the interactive user interface is a dashboard visualization related to asset performance management for one or more assets related to one or more operational processes in an operational environment. In various embodiments, the one or more operational processes are related to the edge devices 161a-161n (e.g., the edge devices 161a-161n included in a portfolio of assets).

In one or more embodiments, the event data structure 306 includes one or more asset descriptors that describe a particular type of one or more assets. For instance, in one or more embodiments, the event data structure 306 includes one or more asset descriptors that describe the edge devices 161a-161n. An asset descriptor includes, for example, asset properties such as an asset name, an asset inheritance identifier, an asset level and/or operational functionalities such as the operational process associated with the asset. Additionally or alternatively, in one or more embodiments, the event data structure 306 includes one or more asset tasks associated with the particular type of asset, such as physical activities associated with the operational functionalities related to the particular type of asset.

In one or more embodiments, the event data structure component 506 is configured to render an inspection round checklist via an interactive user interface (e.g., on the electronic interface component 508). In one or more embodiments, the interactive user interface is configured as a dashboard visualization rendered via a display of a user computing device. In one or more embodiments, the interactive user interface is associated with the edge devices 161a-161n (e.g., the edge devices 161a-161n included in a portfolio of assets). In one or more embodiments, the interactive user interface is configured to provide prioritized actions related to an inspection round checklist, where an inspection round checklist is a series of one or more operational steps related to a scheduled inspection round to be carried out by an industrial plant operator. In one or more embodiments, the event data structure component 506 renders (e.g., by way of the electronic interface component 508) the inspection round checklist as respective interactive display elements on the interactive user interface. An interactive display element is a portion of the interactive user interface (e.g., a user-interactive electronic interface portion) that provides interaction with respect to a user of the user computing device. For example, in one or more embodiments, an interactive display element is an interactive display element associated with a set of pixels that allows a user to provide feedback and/or to perform one or more actions with respect to the interactive user interface. In an embodiment, in response to interaction with an interactive display element, the interactive user interface is dynamically altered to display one or more altered portions of the interactive user interface associated with different visual data and/or different interactive display elements. Additionally, in one or more embodiments, the electronic interface component 508 is configured to facilitate execution and/or initiation of one or more actions via the dashboard visualization. In an embodiment, an action is executed and/or initiated via an interactive display element of the dashboard visualization. In certain embodiments, the interactive user interface presents one or more notifications associated with visualization data 520.

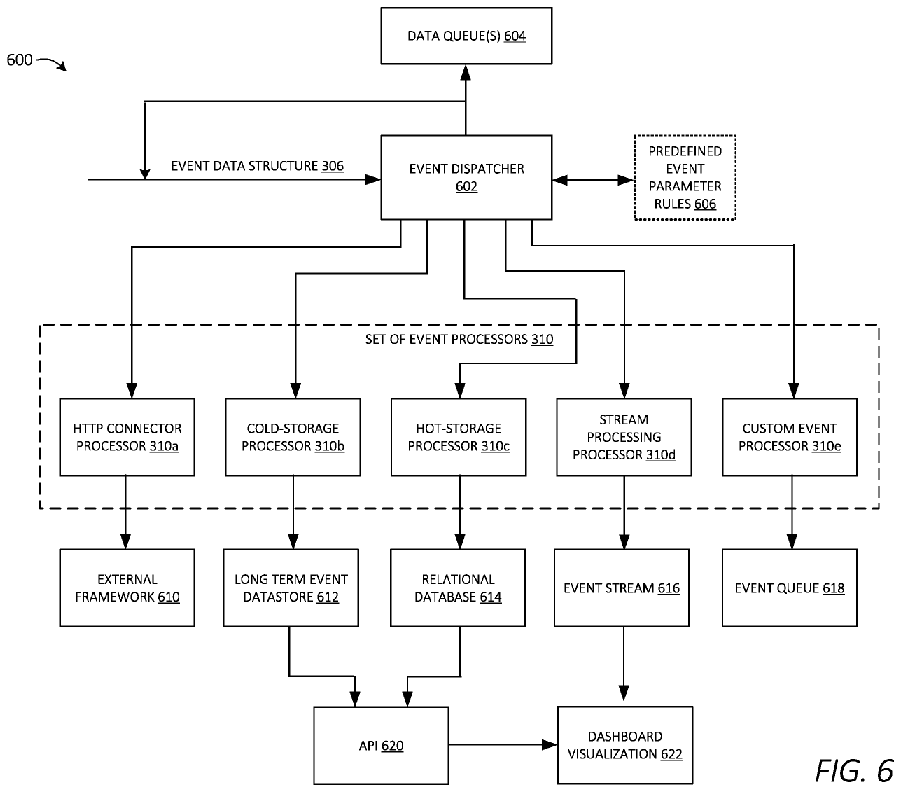

FIG. 6 illustrates a system 600 according to one or more described features of one or more embodiments of the disclosure. The system 600 includes an event dispatcher 602, one or more data queues 604, and/or the set of event processors 310. In one or more embodiments, the set of event processors 310 includes an HTTP connector processor 310a, a cold-storage processor 310b, a hot-storage processor 310c, a stream processing processor 310d, and/or a custom event processor 310c.

The event dispatcher 602 manages routing of the event data structure 306. In one or more embodiments, the event dispatcher 602 can be implemented via the event processor system 302 such as, for example, the event data structure analysis component 404 and/or the event processor selection component 406. In one or more embodiments, the event dispatcher 602 compares at least one event parameter identifier of the event data structure 306 to a set of predefined event parameter rules 606 for the HTTP connector processor 310a, the cold-storage processor 310b, the hot-storage processor 310c, the stream processing processor 310d, and/or the custom event processor 310e. In response to a determination that the at least one event parameter identifier satisfies one or more of the set of predefined event parameter rules 606 for the respective event processors, the event dispatcher 602 can route the event data structure 306 to a particular event processor from the set of event processors 310 in which one or more of the predefined event parameter rules are satisfied. However, in response to a determination that the at least one event parameter identifier does not satisfy the set of predefined event parameter rules 606 for the respective event processors, the event dispatcher 602 can route the event data structure 306 to the one or more data queues 604 for future processing of the event data structure 306. In certain embodiments, the one or more data queues 604 can include a first data queue to allow a retry comparison of the event data structure 306 with respect to the predefined event parameter rules, and a second data queue to further store the event data structure 306 in response to a failure of the retry.

The HTTP connector processor 310a can be configured to redirect the event data structure 306 to an external framework 610 based on data associated with the least one event parameter identifier and/or the event data of the event data structure 306. The external framework 610 can be configured for executing monitoring, analyzing, machine learning, data engineering, insights, and/or other processing related to the event data structure 306. In certain embodiments, the external framework 610 can be implemented at a particular HTTP endpoint of the network 110. In certain embodiments, the external framework 610 can be realized via a single-node machine or a cluster of machines for executing monitoring, analyzing, machine learning, data engineering, insights, and/or other processing related to the event data structure 306. The cold-storage processor 310b can be configured to store the event data structure 306 and/or the event data in a long term event datastore 612 (e.g., a cold-storage associated with long term event storage) associated with data archiving functionality. The hot-storage processor 310c can be configured to store the event data structure 306 and/or the event data in a relational database 614 (e.g., a hot-storage associated with short term event storage) associated with data querying functionality. The stream processing processor 310d can be configured to allocate the event data structure 306 and/or the event data to an event stream 616 for rendering of visualization data (e.g., the visualization data 520) associated with the event data structure 306 via a dashboard visualization 622. The dashboard visualization 622 can be rendered via an electronic interface of the user computing device system 303. In certain embodiments, data stored in the long term event datastore 612 and/or the relational database 614 can be rendered via the dashboard visualization 622. In certain embodiments, an API 620 such as, for example, an event finder REST API can transform data from the long term event datastore 612 and/or the relational database 614 into the visualization data (e.g., the visualization data 520) rendered via the dashboard visualization 622. The custom event processor 310e can be configured to store the event data structure 306 in an event queue 618 based on data associated with the least one event parameter identifier and/or the event data of the event data structure 306. The event queue 618 can be configured to temporarily store the event data structure 306 to facilitate monitoring. analyzing, machine learning, data engineering, insights, and/or other processing related to the event data structure 306.

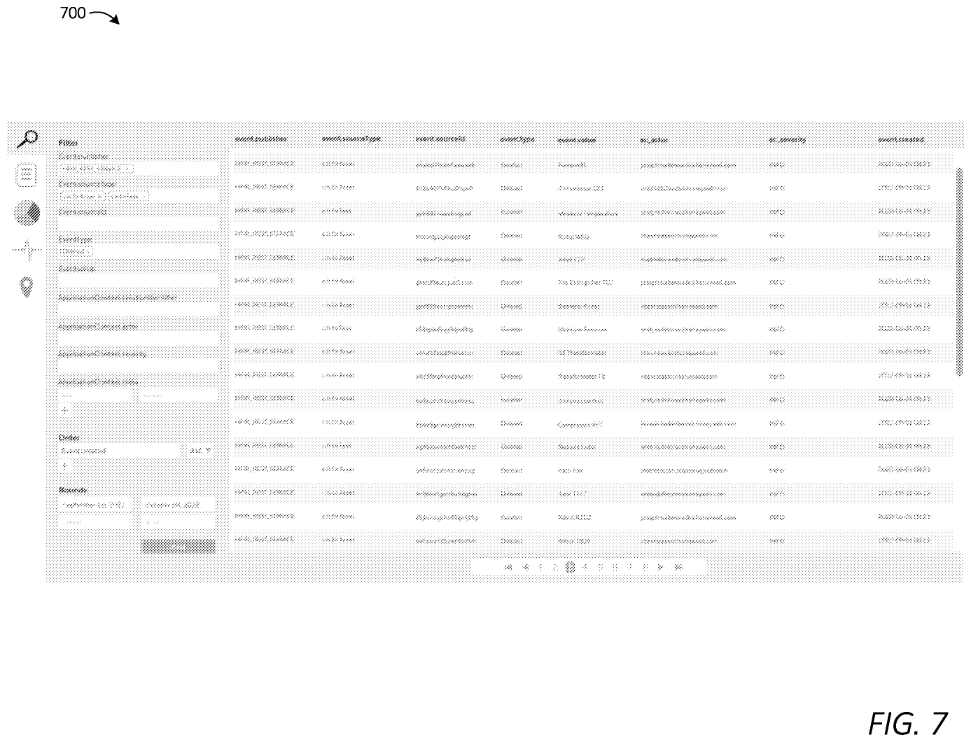

FIG. 7 illustrates an exemplary electronic interface 700 according to one or more embodiments of the disclosure. In an embodiment, the electronic interface 700 is an electronic interface of the user computing device system 303. In one or more embodiments, the electronic interface 700 is presented via the dashboard visualization 622. In one or more embodiments, the data visualization presented via the electronic interface 700 presents a visualization of contextual data, insights, metrics, and/or other analytics for related to one or more event data structures including at least the event data structure 306.

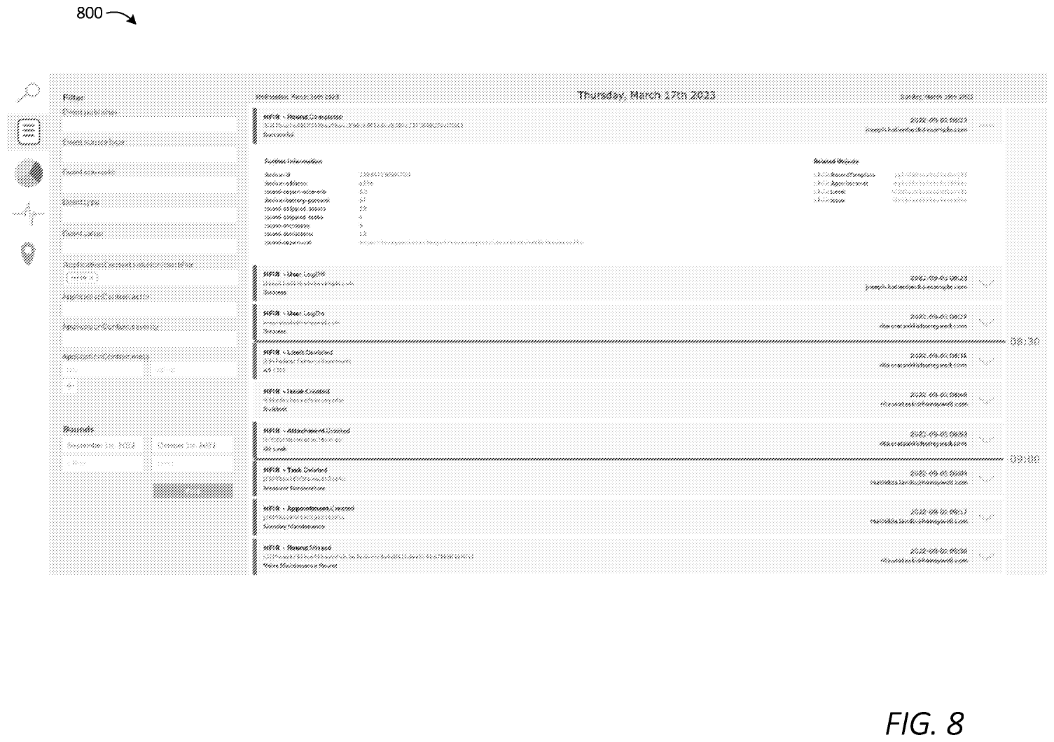

FIG. 8 illustrates an exemplary electronic interface 800 according to one or more embodiments of the disclosure. In an embodiment, the electronic interface 800 is an electronic interface of the user computing device system 303. In one or more embodiments, the electronic interface 800 is presented via the dashboard visualization 622. In one or more embodiments, the data visualization presented via the electronic interface 800 presents a visualization of contextual data, insights, metrics, and/or other analytics for related to one or more event data structures including at least the event data structure 306.

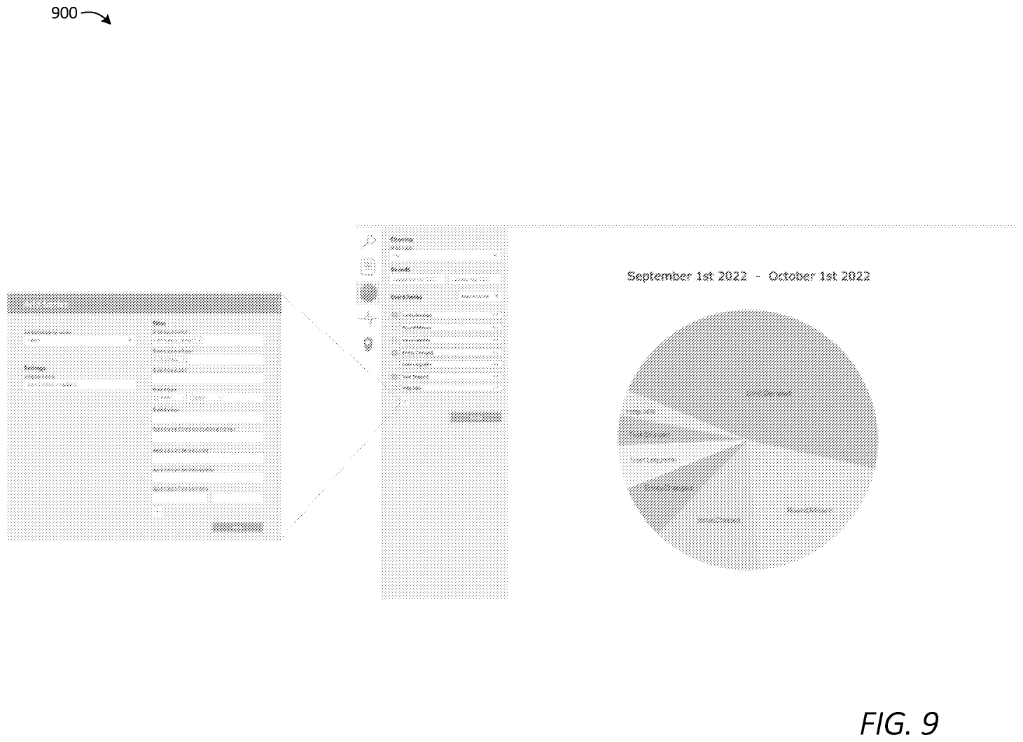

FIG. 9 illustrates an exemplary electronic interface 900 according to one or more embodiments of the disclosure. In an embodiment, the electronic interface 900 is an electronic interface of the user computing device system 303. In one or more embodiments, the electronic interface 900 is presented via the dashboard visualization 622. In one or more embodiments, the data visualization presented via the electronic interface 900 presents a visualization of contextual data, insights, metrics, and/or other analytics for related to one or more event data structures including at least the event data structure 306.

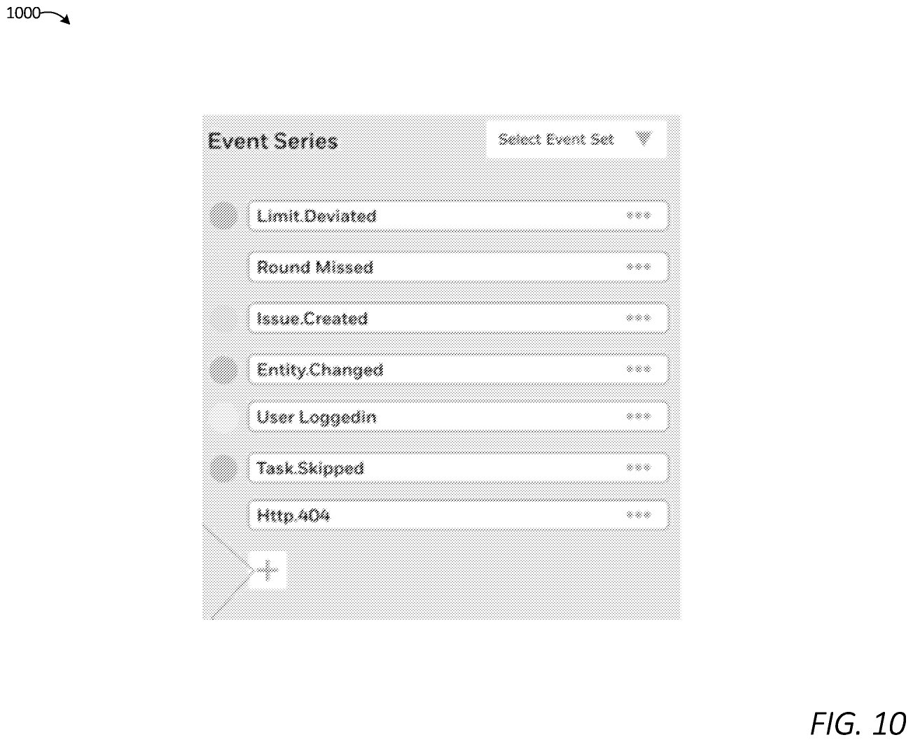

FIG. 10 illustrates an exemplary electronic interface 1000 according to one or more embodiments of the disclosure. In an embodiment, the electronic interface 1000 is an electronic interface of the user computing device system 303. In one or more embodiments, the electronic interface 1000 is presented via the dashboard visualization 622. In one or more embodiments, the data visualization presented via the electronic interface 1000 presents user interactive elements to set filtering for contextual data, insights, metrics, and/or other analytics for related to one or more event data structures including at least the event data structure 306.

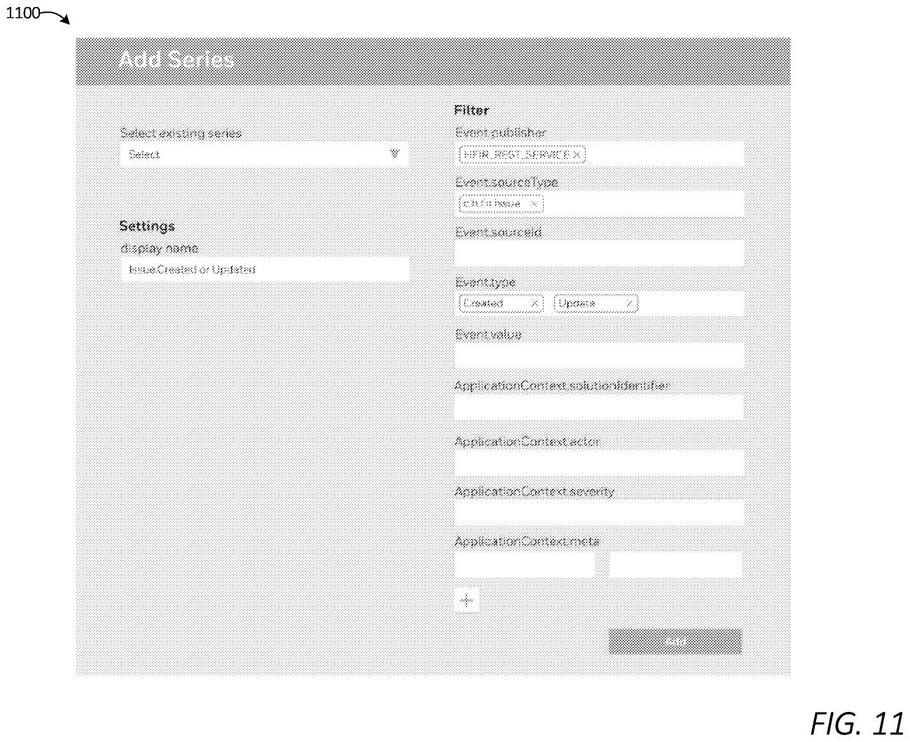

FIG. 11 illustrates an exemplary electronic interface 1100 according to one or more embodiments of the disclosure. In an embodiment, the electronic interface 1100 is an electronic interface of the user computing device system 303. In one or more embodiments, the electronic interface 1100 is presented via the dashboard visualization 622. In one or more embodiments, the data visualization presented via the electronic interface 1100 presents user interactive elements to set filtering for contextual data, insights, metrics, and/or other analytics for related to one or more event data structures including at least the event data structure 306.

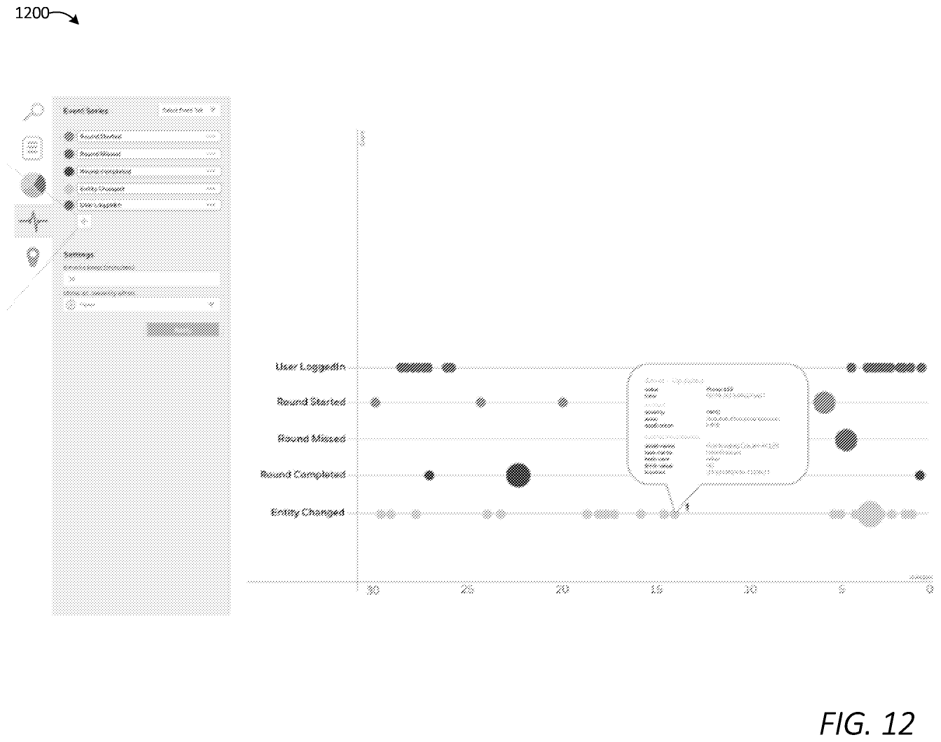

FIG. 12 illustrates an exemplary electronic interface 1200 according to one or more embodiments of the disclosure. In an embodiment, the electronic interface 1200 is an electronic interface of the user computing device system 303. In one or more embodiments, the electronic interface 1200 is presented via the dashboard visualization 622. In one or more embodiments, the data visualization presented via the electronic interface 1200 presents a visualization of contextual data, insights, metrics, and/or other analytics for related to one or more event data structures including at least the event data structure 306.

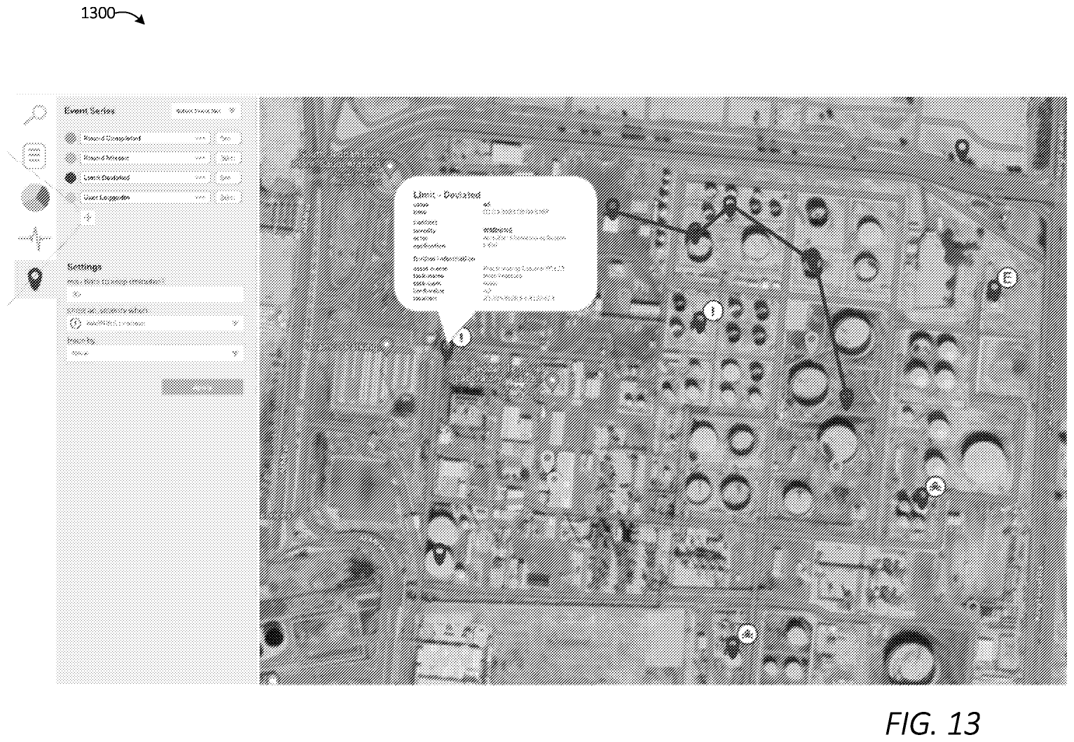

FIG. 13 illustrates an exemplary electronic interface 1300 according to one or more embodiments of the disclosure. In an embodiment, the electronic interface 1300 is an electronic interface of the user computing device system 303. In one or more embodiments, the electronic interface 1300 is presented via the dashboard visualization 622. In one or more embodiments, the data visualization presented via the electronic interface 1300 presents a map visualization of contextual data, insights, metrics, and/or other analytics for related to one or more event data structures including at least the event data structure 306. In one or more embodiments, the contextual data, insights, metrics, and/or other analytics are mapped to a location related to event data structures including at least the event data structure 306. For example, the location can be a geographical location related to capture and/or transmission of event data structures including at least the event data structure 306 via a mobile device.

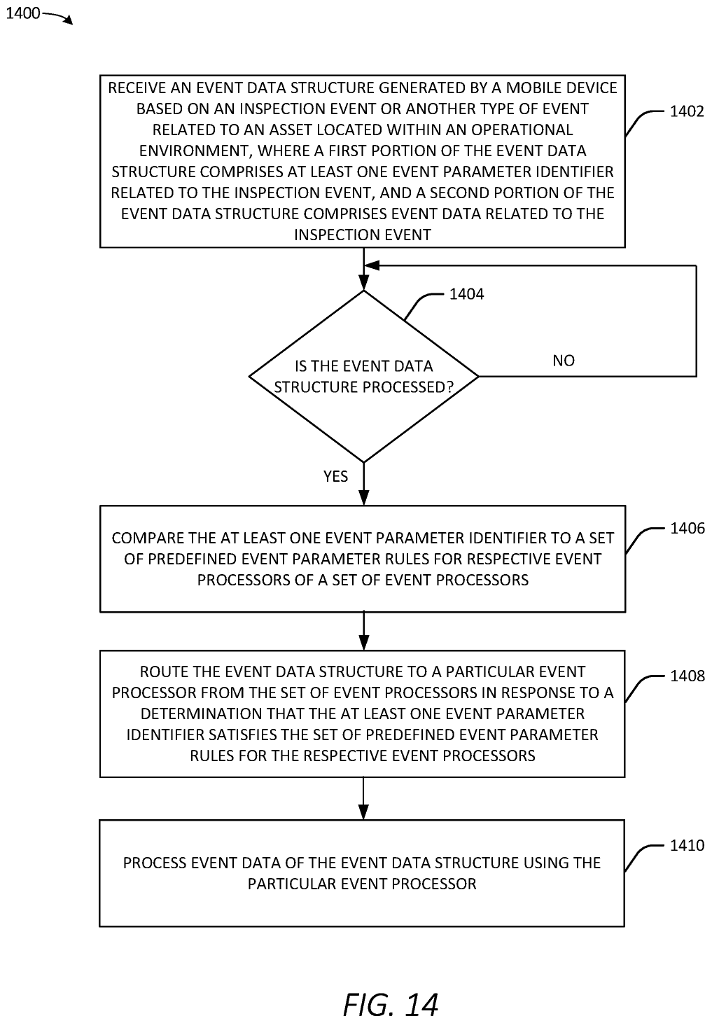

FIG. 14 illustrates a process flow diagram for event data structure routing and/or processing, in accordance with one or more embodiments described herein. In one or more embodiments, the method 1400 is associated with the event processor system 302. Additionally or alternatively, in various embodiments, the method 1400 is associated with the user computing device system 303 in conjunction with the event processor system 302. In one or more embodiments, the method 1400 begins at step 1402 that receives (e.g., by the input/output component 414 and/or the event data structure analysis component 404) an event data structure generated by a mobile device based on an inspection event or another type of event related to an asset located within an operational environment, where a first portion of the event data structure comprises at least one event parameter identifier related to the inspection event, and a second portion of the event data structure comprises event data related to the inspection event. In certain embodiments, the event data structure is generated based on an inspection event related to an industrial asset located within an industrial environment. In certain embodiments, the event data structure is generated based on an event related to a warehouse asset located within a warehouse environment. In one or more embodiments, the event data structure is received from the mobile device in response to a network connection being established between the mobile device and a cloud platform associated with the system. In one or more embodiments, the event data structure is received from the mobile device in response to a determination that the at least one event parameter identifier matches a predefined event parameter identifier included in an API configuration data object for the set of event processors.

At block 1404, it is determined whether the event data structure is processed. For example, it can be determined whether the server system (e.g., the event processor system 302) has processed and/or decrypted the event data structure. If no, block 1404 is repeated to determine whether the event data structure is processed. If yes, the method 1400 proceeds to block 1406. In response to the event data structure, the method 1400 includes a block 1406 that compares (e.g., by the event data structure analysis component 404) the at least one event parameter identifier to a set of predefined event parameter rules for respective event processors of a set of event processors.

In response to the request, the method 1400 additionally or alternatively includes a block 1408 that routes (e.g., by the event processor selection component 406) the event data structure to a particular event processor from the set of event processors in response to a determination that the at least one event parameter identifier satisfies the set of predefined event parameter rules for the respective event processors. In one or more embodiments, prior to being routed to the particular event processor, the event data structure is routed to a data queue for future processing of the event data structure in response to a determination that the at least one event parameter identifier does not satisfy the set of predefined event parameter rules for the set of event processors.

In response to the request, the method 1400 additionally or alternatively includes a block 1410 that processes (e.g., by the event processor selection component 406 and/or an event processor of the set of event processors 310) event data of the event data structure using the particular event processor. In one or more embodiments, the event data structure is transformed into a data format associated with a serializer component of the particular event processor.

In certain embodiment, the particular processor is an HTTP connector processor configured to redirect the event data structure to an HTTP endpoint of a network.

In certain embodiment, the particular processor is a cold-storage processor configured to store the event data structure in a datastore associated with data archiving functionality for event data structures.

In certain embodiment, the particular processor is a hot-storage processor configured to store the event data structure in a relational database associated with data querying functionality for event data structures.

In certain embodiment, the particular processor is a stream processing processor configured to allocate the event data structure to an event stream for rendering of visualization data associated with the event data structure via an electronic interface of the mobile device.

In one or more embodiments, the method 1400 additionally or alternatively includes determining whether the event data of the event data structure exceeds an operational limit. Additionally or alternatively, the method 1400 includes triggering one or more actions associated with an operational process related to the inspection event upon a determination that the operational limit is exceeded. In certain embodiments, the operational process is an industrial process, a warehouse process, or another type of operational process.

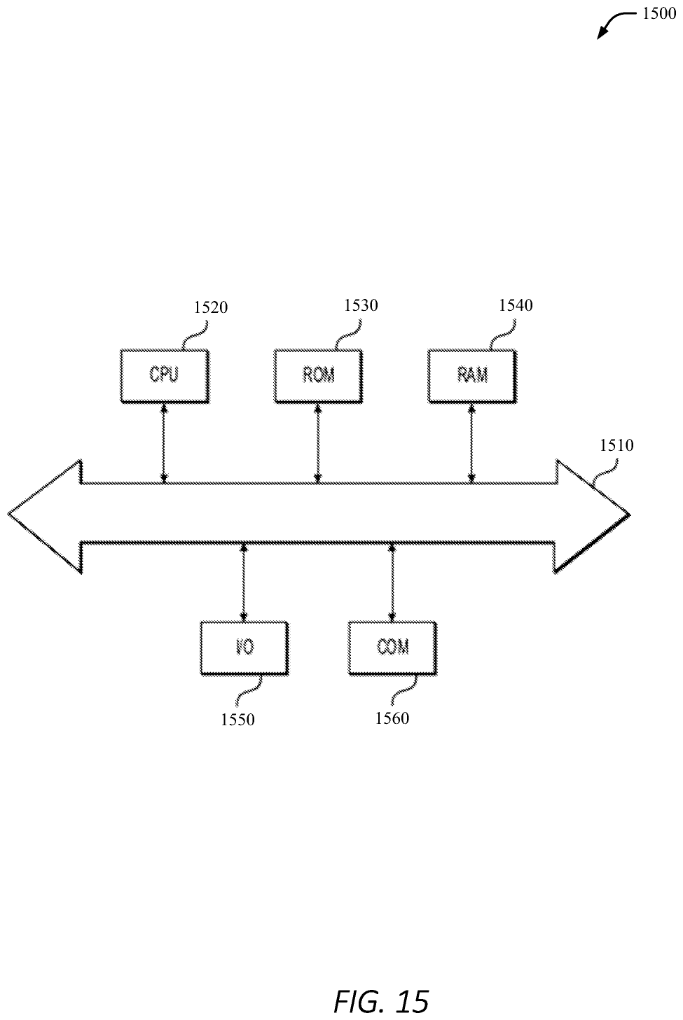

FIG. 15 depicts an example system 1500 that may execute techniques presented herein. FIG. 15 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1560 for packet data communication. The platform also may include a central processing unit (“CPU”) 1520, in the form of one or more processors, for executing program instructions. The platform may include an internal communication bus 1510, and the platform also may include a program storage and/or a data storage for various data files to be processed and/or communicated by the platform such as ROM 1530 and RAM 1540, although the system 1500 may receive programming and data via network communications. The system 1500 also may include input and output ports 1550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VOIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For case of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A system, comprising:
one or more processors;
a memory; and
one or more programs stored in the memory, the one or more programs comprising instructions configured to:
receive an event data structure generated by a mobile device based on an inspection event related to an asset located within an operational environment, wherein a first portion of the event data structure comprises at least one event parameter identifier related to the inspection event, and a second portion of the event data structure comprises event data related to the inspection event; and
in response to the event data structure:
compare the at least one event parameter identifier to a set of predefined event parameter rules for respective event processors of a set of event processors;
route the event data structure to a particular event processor from the set of event processors in response to a determination that the at least one event parameter identifier satisfies the set of predefined event parameter rules for the respective event processors; and
process event data of the event data structure using the particular event processor.

2. The system of claim 1, the one or more programs further comprising instructions configured to:
receive the event data structure from the mobile device in response to a network connection being established between the mobile device and a cloud platform associated with the system.

3. The system of claim 1, the one or more programs further comprising instructions configured to:
receive the event data structure from the mobile device in response to a determination that the at least one event parameter identifier matches a predefined event parameter identifier included in an application programming interface (API) configuration data object for the set of event processors.

4. The system of claim 1, the one or more programs further comprising instructions configured to:
transform the event data structure into a data format associated with a serializer component of the particular event processor.

5. The system of claim 1, the one or more programs further comprising instructions configured to:
route the event data structure to a data queue for future processing of the event data structure in response to a determination that the at least one event parameter identifier does not satisfy the set of predefined event parameter rules for the set of event processors.

6. The system of claim 1, wherein the particular event processor is a hypertext transfer protocol (HTTP) connector processor configured to redirect the event data structure to an HTTP endpoint of a network.

7. The system of claim 1, wherein the particular event processor is a cold-storage processor configured to store the event data structure in a datastore associated with data archiving functionality for event data structures.

8. The system of claim 1, wherein the particular event processor is a hot-storage processor configured to store the event data structure in a relational database associated with data querying functionality for event data structures.

9. The system of claim 1, wherein the particular event processor is a stream processing processor configured to allocate the event data structure to an event stream for rendering of visualization data associated with the event data structure via an electronic interface of the mobile device.

10. The system of claim 8, the one or more programs further comprising instructions configured to:
determine whether the event data of the event data structure exceeds an operational limit; and
trigger one or more actions associated with an operational process related to the inspection event upon a determination that the operational limit is exceeded.

11. A computer-implemented method, the method comprising:
receiving an event data structure generated by a mobile device based on an inspection event related to an asset located within an operational environment, wherein a first portion of the event data structure comprises at least one event parameter identifier related to the inspection event, and a second portion of the event data structure comprises event data related to the inspection event; and
in response to the event data structure:
comparing the at least one event parameter identifier to a set of predefined event parameter rules for respective event processors of a set of event processors;
routing the event data structure to a particular event processor from the set of event processors in response to a determination that the at least one event parameter identifier satisfies the set of predefined event parameter rules for the respective event processors; and
processing event data of the event data structure using the particular event processor.

12. The computer-implemented method of claim 11, wherein receiving the event data structure comprises receiving the event data structure from the mobile device in response to a network connection being established between the mobile device and a cloud platform.

13. The computer-implemented method of claim 11, wherein receiving the event data structure comprises receiving the event data structure from the mobile device in response to a determination that the at least one event parameter identifier matches a predefined event parameter identifier included in an application programming interface (API) configuration data object for the set of event processors.

14. The computer-implemented method of claim 11, wherein processing the event data comprises redirecting the event data structure to a hypertext transfer protocol (HTTP) endpoint of a network.

15. The computer-implemented method of claim 11, wherein processing the event data comprises storing the event data structure in a datastore associated with data archiving functionality for event data structures.

16. The computer-implemented method of claim 11, wherein processing the event data comprises storing the event data structure in a relational database associated with data querying functionality for event data structures.

17. The computer-implemented method of claim 11, wherein processing the event data comprises allocating the event data structure to an event stream for rendering of visualization data associated with the event data structure via an electronic interface of the mobile device.

18. A computer program product comprising at least one computer-readable storage medium having program instructions embodied thereon, the program instructions executable by a processor to cause the processor to:
receive an event data structure generated by a mobile device based on an inspection event related to an asset located within an operational environment, wherein a first portion of the event data structure comprises at least one event parameter identifier related to the inspection event, and a second portion of the event data structure comprises event data related to the inspection event; and
in response to the event data structure:
compare the at least one event parameter identifier to a set of predefined event parameter rules for respective event processors of a set of event processors;
route the event data structure to a particular event processor from the set of event processors in response to a determination that the at least one event parameter identifier satisfies the set of predefined event parameter rules for the respective event processors; and
process event data of the event data structure using the particular event processor.

19. The computer program product of claim 18, wherein the program instructions further cause the processor to:
receive the event data structure from the mobile device in response to a network connection being established between the mobile device and a cloud platform associated with the system.

20. The computer program product of claim 18, wherein the program instructions further cause the processor to:
receive the event data structure from the mobile device in response to a determination that the at least one event parameter identifier matches a predefined event parameter identifier included in an application programming interface (API) configuration data object for the set of event processors.
